(19) United States
(12) Patent Application Publication
(10) Pub. No.: US 2008/0040810 A1
(43) Pub. Date: Feb. 14, 2008

(54) BINDER PROCESSING APPARATUS

(75) Inventor: Takeshi KUROKAWA, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 11/686,414

(22) Filed: Mar. 15, 2007

(30) Foreign Application Priority Data
Aug. 9, 2006 (JP) 2006-216407

(51) Int. Cl. H04L 9/32; H04N 7/16; G06F 17/00

(52) U.S. Cl. 726/27; 726/26; 715/200

(57) ABSTRACT

A binder processing apparatus for processing a binder in which a plurality of electronic documents are grouped specifying an order of displaying the plurality of electronic documents, includes: an access right setting unit that sets access rights for each of the plurality of electronic documents contained in the binder; an access right judgment unit that judges an access right set for an electronic document; and a document processing unit that processes the electronic documenton condition that the access right judgment unit has judged that a positive access right is set for the electronic document.

### CROSS-REFERENCE TO RELATED APPLICATION

This application is based on and claims priority under 35 USC 119 from Japanese Patent Application No. 2006-216407 filed Aug. 9, 2006.

### BACKGROUND

1. Technical Field

The present invention relates to a technique for processing a binder in which a plurality of pieces of document data are grouped by specifying their listed order and more particularly to an access right processing for security protection.

2. Related Art

As creation and editing of various forms of documents are implemented through data processing by a computer, access rights such as browsing right and editing right are set for document data for the purpose of security management for documents, maintenance of uniformity in the contents of documents shared and the like.

In addition, in document processing, data is handled which is grouped as a file or binder in which document data containing a plurality of pages and a plurality of pieces of document data are grouped.

For example, in document data in the form of PDF and Docu Works (trade name of Fuji Xerox Co., Ltd.), a plurality of pages can be bundled into a single document, and when giving an access right such as editing right to a document into which a plurality of pages are bundled, such an access right can be set document by document.

### SUMMARY

According to an aspect of the invention, there is provided a binder processing apparatus for processing a binder in which a plurality of electronic documents are grouped specifying an order of displaying the plurality of electronic documents, including: an access right setting unit that sets access rights for each of the plurality of electronic documents contained in the binder; an access right judgment unit that judges an access right set for an electronic document; and a document processing unit that processes the electronic documenton condition that the access right judgment unit has judged that a positive access right is set for the electronic document.

### BRIEF DESCRIPTION OF THE DRAWINGS

Embodiments of the present invention will be described in detail based on the following figures, wherein:

FIG. 1 illustrates a diagram which shows the configuration of a binder processing apparatus according to an aspect of an exemplary embodiment of the invention;

FIG. 2 illustrates a diagram which illustrates the concept of a binder according to an aspect of the exemplary embodiment of the invention;

FIG. 3 illustrates a diagram which illustrates a data configuration of the binder according to an aspect of the exemplary embodiment of the invention;

FIG. 4 illustrates a diagram which illustrates an example of screen display of the binder according to an aspect of the exemplary embodiment of the invention;

FIG. 5 illustrates a diagram which illustrates another example of screen display of the binder according to an aspect of the exemplary embodiment of the invention; and

FIG. 6 illustrates a diagram which illustrates a further example of screen display of the binder according to an aspect of the exemplary embodiment of the invention.

### DETAILED DESCRIPTION

The invention will be described specifically based on an embodiment.

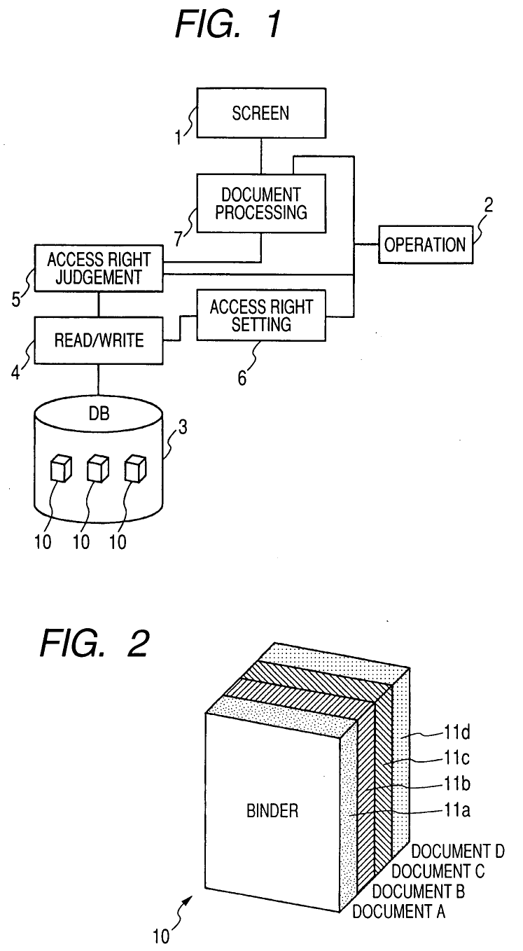

FIG. 1 shows a main configuration of a binder processing apparatus according an embodiment of the invention.

Note that while the binder processing apparatus of this embodiment is realized while realizing the following functions in the configuration of a computer by executing a binder processing program according to the invention on the computer, in the invention, the relevant functions may be configured by hardware.

The binder processing apparatus of the embodiment includes a screen 1 on which an image such as a document is displayed, an operation unit which receives an operation input from a user, a document database 3 that stores and holds data of a binder 10 in which a plurality of pieces of document data are grouped by specifying their listed order, a read/write unit 4 that reads from and writes on to the document data base 3, an access right judgment unit 5 that judges on an access right when the read/write unit 4 reads from the document data base 3, an access right setting unit 6 that sets access rights for pieces of document data, and a document processing unit 7 that performs processings such as displaying data read from the document data base 3 on the screen, editing the data so read and the like.

Here, in this embodiment, the screen 1 is made up of a display unit provided on a computer, the operation unit 2 is made up of a mouse or a keyboard provided on the computer, and the document database 3 is made up of a memory unit provided on the computer.

Note that while in this embodiment, the binder processing apparatus is made up of a stand-alone computer, in the embodiment, a configuration may be adopted in which the document database 3 is made up of a sever on a network, whereby read and write processings from and on to the document database 3 are performed by the read/write unit 4 via the network.

FIG. 2 shows the concept of the binder 10 which is stored and held in the document database 3, and in the illustrated binder 10, four documents (documents A, B, C, D: 11a to 11d) are grouped altogether by specifying their listed order.

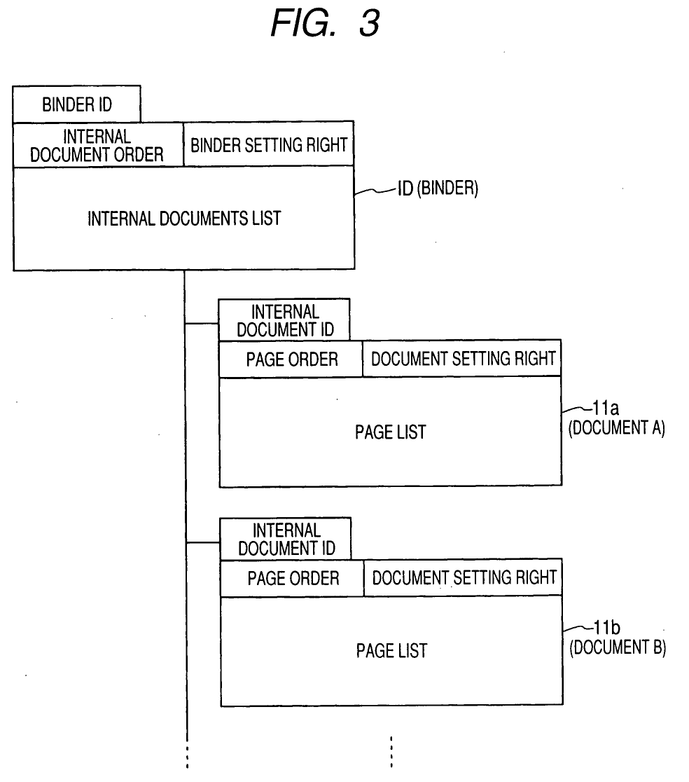

FIG. 3 shows a data configuration of the binder 10, and the binder 10 has a “binder ID” which identifies itself, an “internal document order” which specifies listed orders within the binder 10 of documents (internal documents) contained in itself, a “binder setting right” which is information on access rights which are set in the binder itself thereof, and an “internal documents list” which specifies documents contained in the binder 10 itself.

Namely, when the access right setting unit 6 sets an access right related to document processing such as editing and display in the “binder setting right” in response to user operation from the operation unit 2, a document processing for the binder is controlled in accordance with the access right so set. In addition, a list of “internal document IDs” which identifies individually the documents A to D grouped into the binder 10 is contained in the “internal documents list,” and an order in which the internal documents A to D are listed within the binder (namely, a listed order of A, B, C, D) is specified by information set in the “internal documents order.” Consequently, by changing the “internal documents order,” the listed order of the internal documents A to D in the binder can be changed.

In addition, pieces of data 11a to 11d of the internal documents A to D are related to the “internal documents list” of the binder 10, and the pieces of internal document data 11a to 11d each have an “internal document ID” which identifies itself, a “page order” which specifies a listed order for pages in a document contained therein, a “document setting right” which is information on an access right set for a document itself that is contained therein and a “page list” which specifies pages contained therein.

Namely, when the access right setting unit 6 sets an access right related to document processing such as editing and displaying in the “document setting right” in response to user operation from the operation unit 2, a document processing for the document is controlled in accordance with the access right so set. In addition, a list of page IDs which identifies individually the pages grouped into the document is contained in the “page list,” and an order in which the pages are listed within the document is specified by information set in the “page order.” Consequently, by changing the “page order,” the listed order of the pages in the document can be changed.

Real data, which is the entity of the page, may be made to be held in the “page list,” and the page ID may be made to be held in the “page list” so that the real data of the page which is held in one other memory domain is related to the page ID to be read therefrom.

In the binder processing apparatus of the embodiment, access rights will be set in the following manner for a binder and its internal documents which are held in the document database 13 or for a binder and its documents which are made to be held in the document database 13.

When the user designates a binder or an internal document contained in the binder by their IDs or the like from the operation unit 2 and inputs an access right, the access setting unit 6 sets the access right inputted into the “binder setting right” for the designated binder or the “document setting right” for the designated internal document.

For example, when prohibiting the screen display of the contents of all documents contained in a binder or the contents of each internal document, a negative access right such as “display prohibited” is set in the “binder setting right” of the relevant binder or the “document setting right” of the relevant document. In addition, when prohibiting the editing of all documents contained in the binder or the editing of each internal document, a negative access right such as “editing prohibited” is set in the “binder setting right” of the relevant binder or the “document setting right” of the relevant document. The same thing occurs when other access rights are adopted such as copying right, editing right for annotation (notes), printing right and the like.

In addition, although positive access rights such as permission for display or permission for editing may be set in the “binder setting right” and “document setting right” in an explicit fashion, when no negative access right is set, an access right judgment may be performed on the assumption that a positive access right is set.

Consequently, access rights can be set individually for the internal documents 11a to 11d which are grouped into the binder 10 for the purpose of security protection, and similarly, an access right can be set for the binder 10 itself.

By this configuration, since an access right can be set for each document in the binder which has a plurality of pages, the complexity and troublesomeness can be solved which has to be experienced in setting access rights page by page. In addition, since access rights are set document by document, documents can be changed in position (change in the listed order) with their set access rights held as they are. In addition, since access rights are set document by document, the access rights of the documents are changed in no case even though the documents are fetched into or extracted from the binder. Consequently, the security management document by document is eased. In addition, since access rights can be set for the binder itself and its internal documents, a flexible access right setting can be applied to the documents.

Here, in this embodiment, in the event that an operation is entered in which the internal documents are disassembled from the binder 10 so as to create a new document on the outside thereof (an operation for taking out the internal document from the binder), the access right setting unit 6 continues to hold the setting of the access right for the document and the new document is made to hold the originally set access right.

In addition, in the event that an operation is entered in which an external document is bundled into the binder 10 (an operation for fetching a new document into the binder), the access right setting unit 6 accepts the access right set for the document. Consequently, the external document is bundled into the binder while keeping its access right.

In addition, the access right setting unit 6 may be made to carry out an access right setting in which access rights are set for the individual internal documents in different types of security modules. For example, an internal document for which an access right is set by a password and an internal document for which an access right is set by an electronic seal may be grouped into a single binder.

Additionally, the access right setting unit 6 may set such that different users are given different electronic seals (electronic signatures) so as to be individually allowed to browse document by document (setting for giving browsing rights).

Next, in the binder processing apparatus of the embodiment, when document processings such as screen displaying and editing is implemented on a binder for which the access right is set in such a way as described above, the judgment of the access right will be carried out in the following manner.

When the user designates a binder or an internal document therein by their ID and enters a processing command for screen display or editing from the operation unit 2, the read/write unit 4 reads the binder or the internal document so designated from the document database 3, and the access right judgment unit 5 compares the access right entered in the “binder setting right” of the binder or the “document setting right” of the internal document with the processing command so entered and judges whether or not a processing designated by the entered command is carried out on the binder or the internal document so designated.

In the event that the access right judgment unit 5 judges from the result of the comparison that a positive access right (permission for display, permission for editing or the like) is set, the document processing unit 7 implements a processing according to the entered command such as displaying the contents of a page on the screen or editing the contents of the page on the binder or the document so read.

On the other hand, in the event that the access right set for the binder or the document is judged to be negative, the document processing unit 7 does not implement the processing according to the entered command and posts a message to that effect to the screen 1 for display thereon.

Consequently, the document processing is executed according to the access right set for each binder or internal document.

Here, in the embodiment, in the event that access rights conflicting with each other are set for the binder 10 and its internal document, regarding that the access right of the binder is higher in order, the access right judgment unit 5 performs a judgment.

For example, in the event that a document editing right is not given to the binder but is given to the internal document thereof, the access right judgment unit 5 judges that pages of the internal document cannot be edited with giving preference to the access right of the binder. On the contrary, in the event that the document editing right is given to the binder but is not given to the internal document thereof, the pages of the internal document are allowed to be edited except for moving them to other documents.

Here, as to the binder or the internal document thereof on which the editing processing or screen display processing has been carried out, images of pages contained therein are displayed on the screen 1 as is known, and the document processing unit 7 implements a page turning processing according to an page turning input by the user via the operation unit 2. In the display of pages by turning them, the document processing unit 7 displays pages by turning them while jumping over a document for which a negative access right is set. Namely, in the event that pages are turned sequentially, pages so turned are displayed sequentially with only a document jumped over for which the negative access right is set.

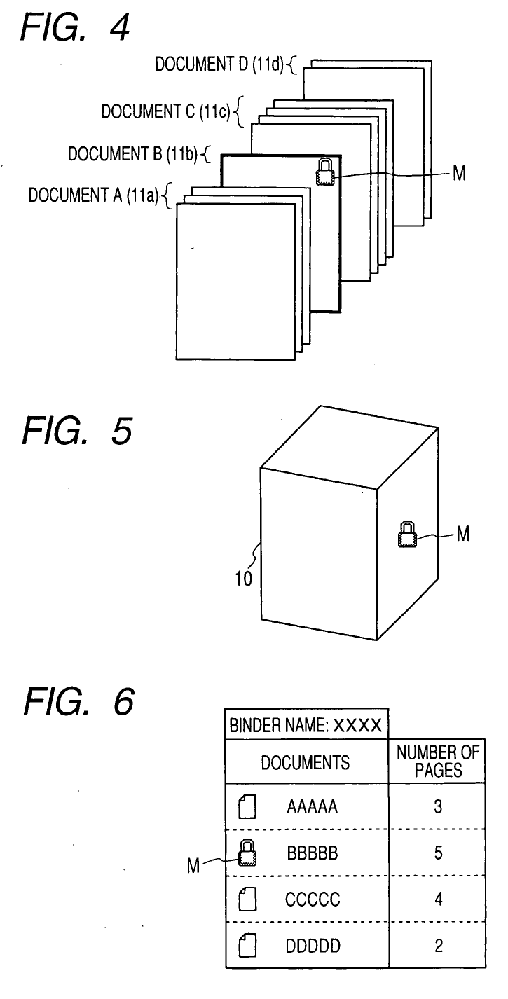

In addition, a binder for which an access right is set in the manner described heretofore is displayed on the screen 1 in a form illustrated in FIGS. 4 to 5 by the document processing unit 7.

In an example depicted in FIG. 4, pages containing the internal documents 11a to 11d which are contained in the binder 10 are displayed one on another in such a manner as to be slightly offset from one another. In this example, since a negative access which prohibits browsing and/or editing is set for the document (B) 11b, according to the result of the judgment by the access right judgment unit 5, the document processing unit 7 displays the document (B) 11b not in the superposed fashion but as a single document. Furthermore, the document processing unit 7 displays additionally a mark (for example, a graphic form of a lock) M which indicates that a negative access right is set for the document (B) 11b.

In addition, in an example shown in FIG. 5, in the event that a negative access right is set for a binder itself or all documents contained in the binder, according to the result of the judgment by the access right judgment unit 5, the document processing unit 7 displays on the screen a mark (for example, a graphic form of a lock) M which indicates that a negative access right is set for the binder 10.

In addition, in an example shown in FIG. 6, in the event that a property of the binder is displayed on the screen 1, since the negative access right is set for the document (B) 11b (document name: BBBBB), according to the result of the judgment by the access right judgment unit 5, the document processing unit 7 displays a mark (for example, a graphic form of a lock) M which indicates that a negative access right is set for the document.

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The exemplary embodiments are chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. A binder processing apparatus for processing a binder in which a plurality of electronic documents are grouped specifying an order of displaying the plurality of electronic documents, comprising:
an access right setting unit that sets access rights for each of the plurality of electronic documents contained in the binder;
an access right judgment unit that judges an access right set for an electronic document; and
a document processing unit that processes the electronic document on condition that the access right judgment unit has judged that a positive access right is set for the electronic document.

2. The binder processing apparatus according to claim 1,
wherein the access right setting unit further sets an access right for the binder, the access right is applied to all of the electronic documents contained in the binder, and
wherein the document processing unit processes an electronic document contained in the binder on condition that the access right judgment unit has judged that a positive access right is set for the binder.

3. The binder processing apparatus according to claim 2,
wherein when access rights set for the binder and an electronic document contained in the binder conflict with each other, the access right judgment unit judges the access right set for the binder in preference to the access right set for the electronic document.

4. The binder processing apparatus according to claim 1,
wherein the document processing unit displays each page of each of the electronic documents in the binder on a screen by turning the pages in response to operation by a user, and
when there is an electronic document for which a negative access right is set, the document processing unit performs a display of pages by turning the pages while jumping over the document for which the negative access right is set.

5. The binder processing apparatus according to claim 1,
wherein the document processing unit displays on a screen each of the electronic documents contained in the binder representing a thickness of each of the electronic documents, and displays an electronic document for which a negative access right is set in a state in which a mark that indicates that no document processing is allowed is attached to the electronic document.

6. A computer readable medium storing a program causing a computer to execute a process for processing a binder in which a plurality of electronic documents are grouped specifying an order of displaying the plurality of electronic documents, the process comprising:
setting access rights for each of the plurality of electronic documents contained in the binder;
judging an access right set for an electronic document contained in the binder; and
processing the electronic document data on condition that the access right set for the electronic document has been judged to be a positive access right.

7. The computer readable medium according to claim 6, the process further comprising:
setting an access right for the binder, the access right is applied to all of the electronic documents contained in the binder, and
processing an electronic document contained in the binder on condition that the access right set for the binder has been judged to be a positive access right.

8. The computer readable medium according to claim 7,
wherein when access rights set for the binder and an electronic document contained in the binder conflict with each other, the access right set for the binder is judged in preference to the access right set for the electronic document.

9. A process in which a binder processing apparatus comprising an access right setting unit, an access right judgment unit and a document processing unit, processes a binder in which a plurality of electronic documents are grouped specifying an order of displaying the plurality of electronic documents, the process comprising:
setting access rights for each of the plurality of electronic documents contained in the binder; and
processing the electronic document data on condition that the access right set for the electronic document has been judged to be a positive access right.

10. A computer data signal embodied in a carrier wave for enabling a computer to perform a process for processing a binder in which a plurality of electronic documents are grouped specifying an order of displaying the plurality of electronic documents, the process comprising:
setting access rights for each of the plurality of electronic documents contained in the binder;
judging an access right set for an electronic document contained in the binder; and
processing the electronic document data on condition that the access right set for the electronic document has been judged to be a positive access right.
